(19) United States
(12) Patent Application Publication
(10) Pub. No.: US 2011/0002016 A1
(43) Pub. Date: Jan. 6, 2011

(54) IMAGE READING APPARATUS AND CONTROL METHOD OF THE SAME

(75) Inventor: Koichi Kuno, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/826,224

(22) Filed: Jun. 29, 2010

(30) Foreign Application Priority Data
Jul. 3, 2009 (JP) 2009-159258

(51) Int. Cl. H04N 1/32

(52) U.S. Cl. 358/468

(57) ABSTRACT

It is an object to provide an image reading apparatus, an image reading method, and a program, in which in the case of reading both of a reflecting original and a transmitting original by one image reading apparatus, an average scanning time in the scan of a plurality of number of times can be shortened without increasing costs. In the image reading apparatus, whether the read original is the reflecting original or the transmitting original is discriminated based on a part of data read as a reflecting original by a reflecting original reading unit. If it is determined that the original is the transmitting original, the original is read as a transmitting original by a transmitting original reading unit. If it is determined that the original is the reflecting original, the data which has been read before is used.

### BACKGROUND OF THE INVENTION

1. Field of the Invention

The present invention relates to an image reading apparatus in which an original is read by an image sensor for converting an original image into an electric image signal and the image signal is processed and output.

2. Description of the Related Art

In the related arts, there is an image reading apparatus having a mode in which in the case of executing a scanning process by using an image processing apparatus, a reflecting original and a transmitting original are automatically discriminated and read out (hereinbelow, referred to as “auto mode scan”) and a mode in which either a reflecting original or a transmitting original is manually designated and read out (hereinbelow, referred to as “manual mode scan”).

In the case of automatically discriminating the reflecting original and the transmitting original, a type of original is first discriminated and, if it is determined that the original is the transmitting original such as a film, a light source for transmitting is turned on, thereby reading the original as a transmitting original. If it is determined that the original is the reflecting original such as a paper original, a light source for reflecting is turned on, thereby reading the original as a reflecting original.

In the case of discriminating the type of original, a technique for discriminating the presence or absence by a sensor is generally used. In the case of discriminating the original type by the sensor, for example, since an original table cover is removed in order to validate the light source for the transmitting original, it is detected that the original table cover has been removed. By detecting that a film guide for setting a film has been put, it is determined that the original is the transmitting original, and a scanning process of the transmitting original is executed.

There has also been known an invention that both of the transmitting original and the reflecting original are read out as an original and which one of them is appropriate is discriminated.

Such a technique that in the case of discriminating the type of original, a prescanning operation is executed, an image as a result of the scan is analyzed, and a specific mark, pattern, or the like is identified, thereby discriminating whether or not the original is the transmitting original has been disclosed in the Japanese Patent Application Laid-Open No. 2004-241838.

However, in the case of discriminating the transmitting original and the reflecting original by hardware, there is a problem of an increase in costs of devices. In the case of discriminating the transmitting original and the reflecting original by prescanning, since a time necessary for the prescanning operation is added to a scanning time, there is such a problem that a final scanning time becomes long.

### SUMMARY OF THE INVENTION

It is an object of the invention to solve the foregoing problems in the related arts.

According to one aspect of the invention, there is provided an image reading apparatus for forming an original image by reading an original, comprising: a reflecting original reading unit configured to read a reflecting original by reflecting light; a transmitting original reading unit configured to read a transmitting original by transmitting the light; an instructing unit configured to instruct an execution of either the reflecting original reading unit or the transmitting original reading unit; an original discriminating unit configured to discriminate whether the read original is the reflecting original or the transmitting original by using a feature of image data read by the reading unit instructed by the instructing unit; and a reading control unit configured to control in such a manner that if a discrimination result of the original discriminating unit indicates that the original is the original which can be read by the reading unit instructed by the instructing unit, an original image is formed by using the image data read by the reading unit, and if the discrimination result of the original discriminating unit indicates that the original is not the original which can be read by the reading unit instructed by the instructing unit, an original image is formed by reading the original by using the other reading unit.

According to another aspect of the invention, there is provided a control method of an image reading apparatus which has a reflecting original reading unit configured to read a reflecting original by reflecting light and a transmitting original reading unit configured to read a transmitting original by transmitting the light and forms an original image by reading the original by using one of the reading units, comprising: an instructing step of instructing an execution of either the reflecting original reading unit or the transmitting original reading unit; an original discriminating step of discriminating whether the read original is the reflecting original or the transmitting original by using a feature of image data read by the reading unit instructed in the instructing step; and a reading control step of controlling in such a manner that if a discrimination result of the original discriminating step indicates that the original is the original which can be read by the reading unit instructed in the instructing step, an original image is formed by using the image data read by the reading unit, and if the discrimination result of the original discriminating step indicates that the original is not the original which can be read by the reading unit instructed in the instructing step, an original image is formed by reading the original by using the other reading unit.

According to another aspect of the invention, there is provided a recording medium in which a program for controlling an image reading apparatus which has a reflecting original reading unit configured to read a reflecting original by reflecting light and a transmitting original reading unit configured to read a transmitting original by transmitting the light and forms an original image by reading the original by using one of the reading units has been recorded, wherein the program comprises: an instructing step of instructing an execution of either the reflecting original reading unit or the transmitting original reading unit; an original discriminating step of discriminating whether the read original is the reflecting original or the transmitting original by using a feature of image data read by the reading unit instructed in the instructing step; and a reading control step of controlling in such a manner that if a discrimination result of the original discriminating step indicates that the original is the original which can be read by the reading unit instructed in the instructing step, an original image is formed by using the image data read by the reading unit, and if the discrimination result of the original discriminating step indicates that the original is not the original which can be read by the reading unit instructed in the instructing step, an original image is formed by reading the original by using the other reading unit.

Further features of the present invention will become apparent from the following description of exemplary embodiments with reference to the attached drawings.

### BRIEF DESCRIPTION OF THE DRAWINGS

FIG. 1 is a cross sectional view of an image reading apparatus 100 according to an embodiment 1 of the invention.

FIG. 2 is a block diagram illustrating a functional construction of a scanner main body 101 in the embodiment.

FIG. 3 illustrates a schematic construction of a host PC 221 in the embodiment.

FIG. 4 is a flowchart illustrating a whole flow of an auto mode scan.

FIG. 5 is a schematic flowchart of an auto mode original type discrimination (S01).

FIGS. 6A and 6B illustrate images in the case where the whole area of an original table has been read.

FIGS. 7A, 7B, 7C and 7D illustrate areas each of which is read out in order to identify an original.

FIG. 8 is a flowchart illustrating an auto mode scan of a reflecting original (S03).

FIG. 9 is a flowchart illustrating the operation of an embodiment 2 of the invention.

FIG. 10 is a flowchart illustrating an auto mode scan of a transmitting original (S04).

### DESCRIPTION OF THE EMBODIMENTS

Preferred embodiments of the present invention will now be described in detail in accordance with the accompanying drawings.

### Embodiment 1

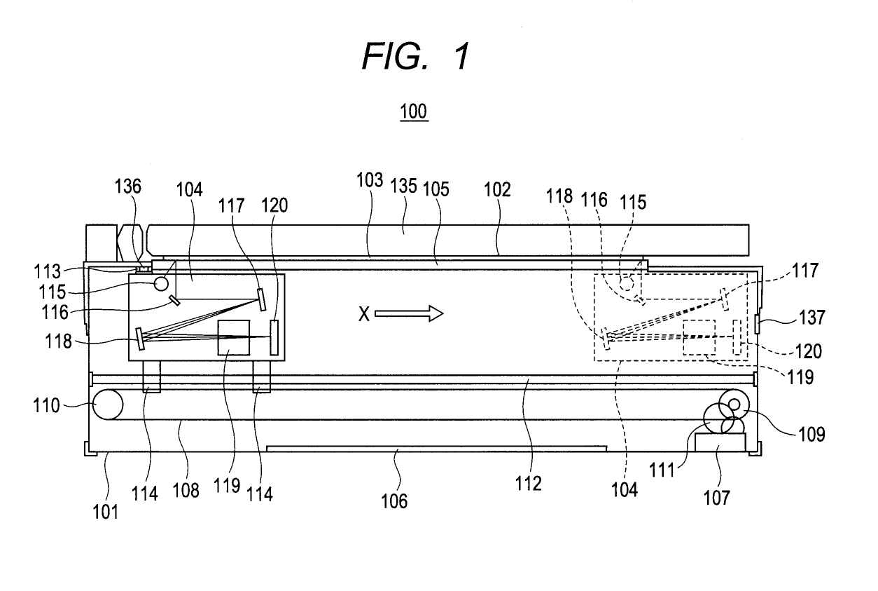

FIG. 1 is a cross sectional view of an image reading apparatus 100 according to an embodiment 1 of the invention. The image reading apparatus 100 has a scanner main body 101 and a transmitting original unit 102.

The scanner main body 101 is connected to a host PC by an interface cable (not shown). The host PC is a host computer. The scanner main body 101 has a movement optical unit 104, an original table glass 105, an electric board 106, a pulse motor 107, an endless belt 108, pulleys 109 and 110, a gear train 111, a guide rail 112, and a white reference plate 113.

A black mark 136 is formed in the white reference plate 113. The scanner main body 101 decides a reading area by using the black mark 136 as a reference and reads out an image. The movement optical unit 104 and the pulse motor 107 are electrically connected by a cable (not shown). The movement optical unit 104 is slidably set by a mounting portion 114 through the guide rail 112. The mounting portion 114 is fixed to the endless belt 108.

The movement optical unit 104 has a light source 115 for the reflecting original, a plurality of reflecting mirrors 116, 117, and 118, an imaging lens 119, and a line sensor 120 serving as an image pickup unit.

The electric board 106 is an example of an original discriminating unit for discriminating whether the read original is a reflecting original or a transmitting original based on a part of data read out as a reflecting original by a reflecting original reading unit. The electric board 106 is also an example of a control unit for controlling in such a manner that if it is determined by the original discriminating unit that the original is the transmitting original, the original is read as a transmitting original by a transmitting original reading unit, and if it is determined by the original discriminating unit that the original is the reflecting original, the data which has already been read is used.

Subsequently, the reading operation of the reflecting original in the scanner main body 101 will be described. The scanner main body 101 starts the reading operation in response to a read command from the host PC. When the reflecting original is designated, the scanner main body 101 turns on the light source 115 for the reflecting original of the movement optical unit 104. Reflection light from a reading original 103 is reflected by a plurality of reflecting mirrors 116, 117, and 118 and formed as an image onto the line sensor 120 through the imaging lens 119. Thus, the image of one line in a main scan direction is read. When the transmitting original is designated, the scanner main body 101 turns on the light source 135 for the transmitting original of a transmitting original unit 102. Transmitted light through the transmitting original 103 is reflected by the plurality of reflecting mirrors 116, 117, and 118 and formed as an image onto the line sensor 120 through the imaging lens 119. Thus, the image of one line in the main scan direction is read.

A motive power of the pulse motor 107 rotates the pulley 109 through the gear train 111, thereby driving the endless belt 108. Thus, the movement optical unit 104 fixed onto the mounting portion 114 is moved on the guide rail 112 in a sub scan direction shown by an arrow X through the endless belt 108.

While moving the movement optical unit 104 in the sub scan direction, the scanner main body 101 repeats the reading operation of the line image in the main scan direction. The scanner main body 101 moves the movement optical unit 104 to a position shown by a broken line in FIG. 1 while executing the reading operation, thereby enabling the whole area of the original table glass 105 to be scanned.

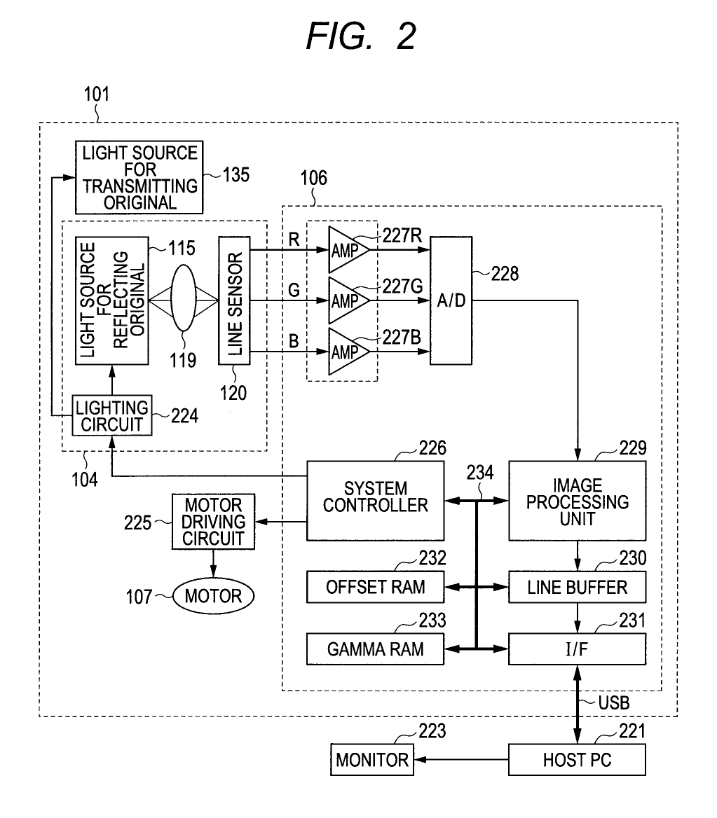

FIG. 2 is a block diagram illustrating a functional construction of the scanner main body 101 in the embodiment. The same component elements as those illustrated in FIG. 1 are designated by the same reference numerals. In the movement optical unit 104, a light source lighting circuit 224 is a circuit for turning on the light source 115 for the reflecting original and a light source 135 for the transmitting original. A detecting unit for detecting a light amount of the light source is included in the light source lighting circuit 224. If a cold-cathode tube is used as each of the light source 115 for the reflecting original and the light source 135 for the transmitting original, what is called an inverter circuit is used.

In the electric board 106, analog gain controllers 227R, 227G, and 227B can variably amplify analog image signals generated from the line sensor 120, respectively. An A/D converter 228 converts the analog image signals output from the analog gain controllers 227R, 227G, and 227B into a digital image signal.

An image processing unit 229 executes image processes such as offset correction, shading correction, digital gain control, color balance control, masking, resolution conversion in the main/sub scan directions, image compression, and the like to the digital image signal. A line buffer 230 temporarily stores the image data. A general-use random access memory is used as a line buffer 230.

An I/F (interface) 231 is provided to communicate with a host PC 221. Although a USB interface is used here, another interface such as IEEE1394 or network may be used.

An offset RAM 232 is used as a working area when executing the image processes. Since line sensors for RGB are arranged in parallel in the line sensor 120 so as to have a predetermined offset, respectively, the offset RAM 232 is used as correction values of the offsets among the RGB lines. The offset RAM 232 temporarily stores various kinds of data for the shading correction and the like. A general-use random access memory is used as an offset RAM 232. A gamma RAM 233 is used to store a gamma curve and make gamma correction.

A sequence for the whole film scanner has been stored in a system controller 226. The system controller 226 makes various kinds of control in response to commands from the host PC 221. The system controller 226, image processing unit 229, line buffer 230, I/F 231, offset RAM 232, and gamma RAM 233 are mutually connected by a CPU bus 234. The CPU bus 234 is constructed by an address bus and a data bus.

A motor driving circuit 225 is used to drive the pulse motor 107. The motor driving circuit 225 outputs an excitation switching signal of the pulse motor 107 in response to a signal from the system controller 226 serving as a system control unit of the scanner main body 101.

Subsequently, a schematic construction of the host PC 221 which is used in the control of the scanner main body 101 will be described.

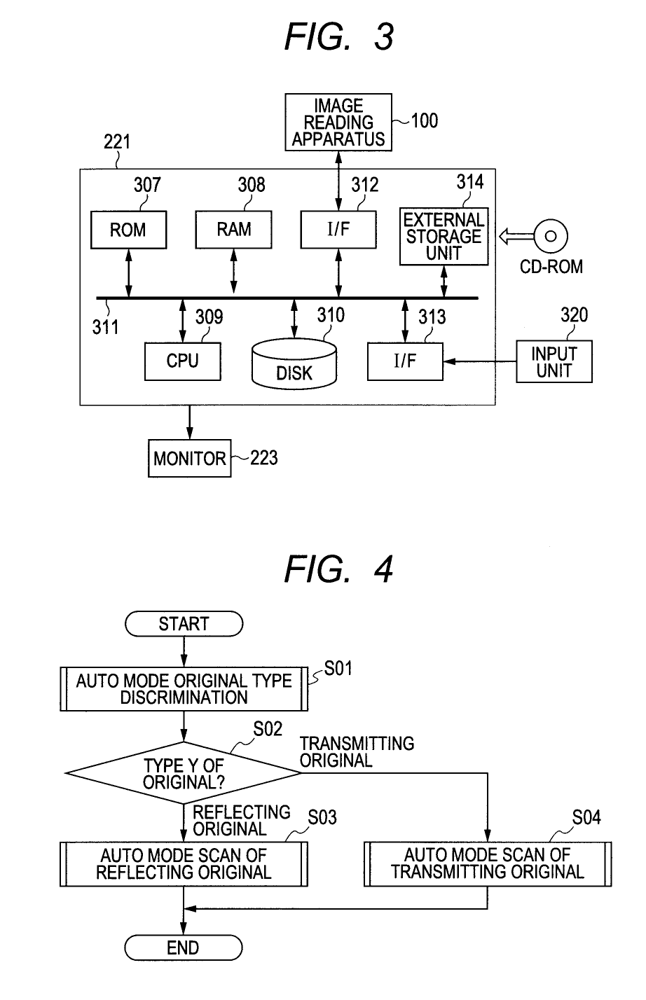

FIG. 3 is a diagram illustrating the schematic construction of the host PC 221 which is used in the control of the scanner main body 101 in the embodiment. The host PC 221 has a ROM 307, a RAM 308, a central processing unit (CPU) 309, a disk unit 310, a bus 311, an I/F 312, an I/F 313, and an external storage unit 314.

A program for realizing control steps in the embodiment 1 has been held in the ROM 307. The RAM 308 is a storing area and a work area which are necessary for the operation of the foregoing program. The CPU 309 executes processes according to the program held in the ROM 307.

The bus 311 is provided to connect the foregoing component elements and enable data to be transmitted and received among them. The I/F 312 is an interface to communicate with the scanner main body 101 provided in the image reading apparatus 100. Although the I/F 312 is realized by a USB interface in a manner similar to the I/F 231 of the scanner main body 101, another interface such as IEEE1394 or network may be used. The I/F 313 is connected to an input unit 320 such as mouse or keyboard.

The external storage unit 314 is provided to drive an external storage medium such as a CD-ROM. In place of preliminarily holding a control program into the ROM 307 as mentioned above, if the control program has been stored in the external storage medium, it is read out and downloaded. The control program may be downloaded through a network connector (not shown) via a network.

Subsequently, a control method of the auto mode scan in the image reading apparatus 100 will be described. The host PC 221 allows the scanner main body 101 to read the image several times, thereby realizing the auto mode scan. The auto mode scan is started by clicking an auto mode scan execution button (not shown) of the host PC 221 or is started by an auto scan execution button (not shown) on the scanner main body 101.

FIG. 4 is a flowchart illustrating a whole flow of the auto mode scan.

When the auto mode scan is started, first, in S01, an original type Y is discriminated by an auto mode original type discriminating process. If it is determined in S02 that the original type Y indicates the reflecting original in the condition discrimination (S01), the auto mode scan of the reflecting original is executed in S03. If the original type Y indicates the transmitting original, the auto mode scan of the transmitting original is executed in S04.

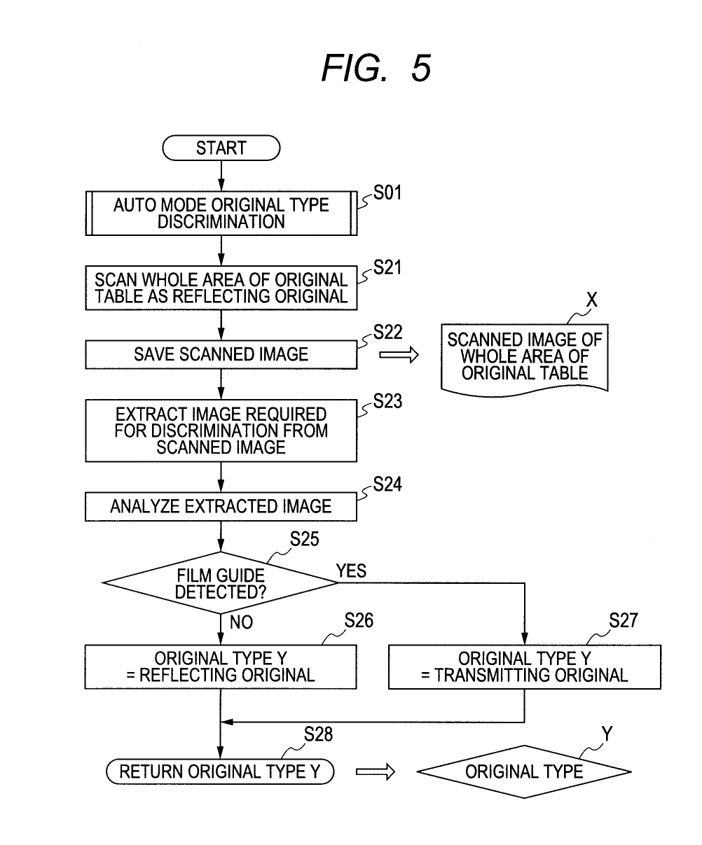

FIG. 5 is a flowchart schematically illustrating the operation of the auto mode original type discrimination (S01) illustrated in FIG. 4.

First, in S21, the whole area of the original table is scanned. In S22, an original table whole area scanned image X as a result of the scan of the whole area of the original table is saved.

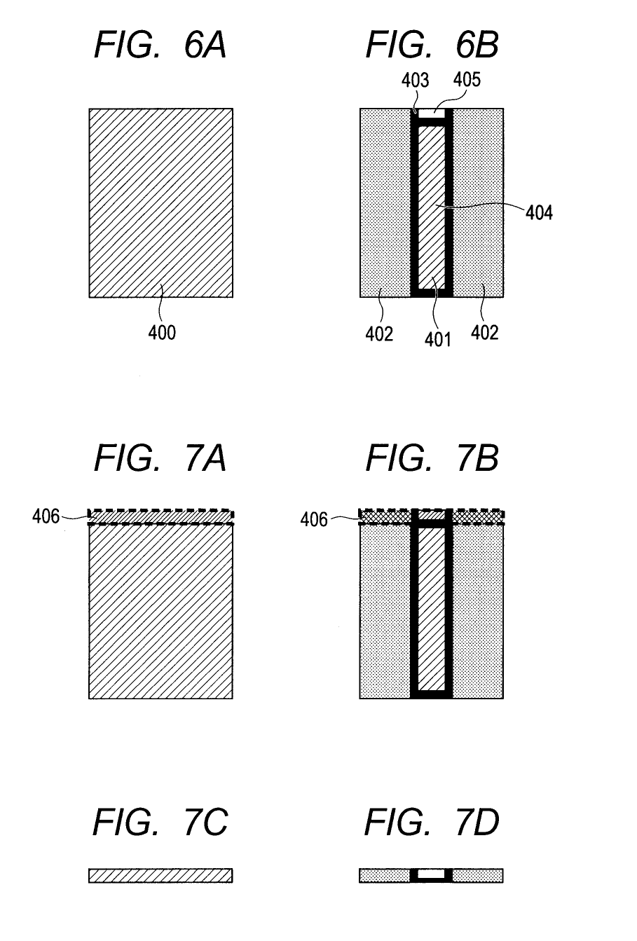

FIGS. 6A and 6B are diagrams illustrating images in the case where the whole area of the original table has been read.

FIG. 6A is a diagram illustrating the image which is obtained by scanning the whole area of the original table when the reflecting original has been put onto the table.

In the case of the reflecting original, since the original can be put onto the whole area of the original table, a reflection scanning area 400 coincides with the whole area of the original table. If the original does not exist, a white reflecting plate set on a top plate exists.

FIG. 6B is a diagram illustrating the image which is obtained by scanning the whole area of the original table when the transmitting original has been put onto the table.

An area where the transmitting original can be put is an area shown by a film preview area 401. When the transmitting original is put, a film guide 403 is put onto the table so that the original can be set to a correct position, and the transmitting original is set into a film setting area 404.

The film guide is made of a material which is difficult to reflect and transmit the light. Upon scanning, an image becomes a dark image. A notch exists partially in the film guide. Such a notch becomes an area, that is, a film calibration window 405 adapted to perform calibration of the scanner upon scanning of the transmitting original.

The film calibration window 405 can transmit the transmitting original of 100% upon scanning, a bright image is obtained. In the case of the transmitting original, a reflecting plate at the time of the reflecting original is removed and a film preview outer area 402 as an area of the original table other than the film preview area becomes a material of the device main body which is exposed. Ordinarily, they are black materials which are difficult to reflect.

By comparing the images in the areas where a difference between both of the originals is caused, which one of the originals has been put is discriminated. Areas which are fixed in the transmitting original are the film calibration window, film guide, and film preview outer area.

Although the film preview outer area 402 reaches the whole area of the original table, such a discrimination can be made by paying attention to the areas of the film calibration window and the film guide.

FIGS. 7A, 7B, 7C and 7D are diagrams each illustrating an area which is read in order to identify the original.

The diagrams obtained by extracting the areas in FIGS. 7A and 7B are FIGS. 7C and 7D. Since the image illustrated in FIG. 7B is a fixed image, the presence or absence of the film guide for the transmitting original can be discriminated by a degree of coincidence with it.

Returning to FIG. 5, in S23, an original type discriminating area 406 is cropped from the original table whole area scanned image X. In S24, the cropped scanned image is analyzed, thereby discriminating the presence or absence of the film guide. When the film guide is detected, in S27, the transmitting original is set into a function as an original type Y. If the film guide is not detected, in S26, the reflecting original is set into a function as an original type Y. In S28, the original type Y is returned.

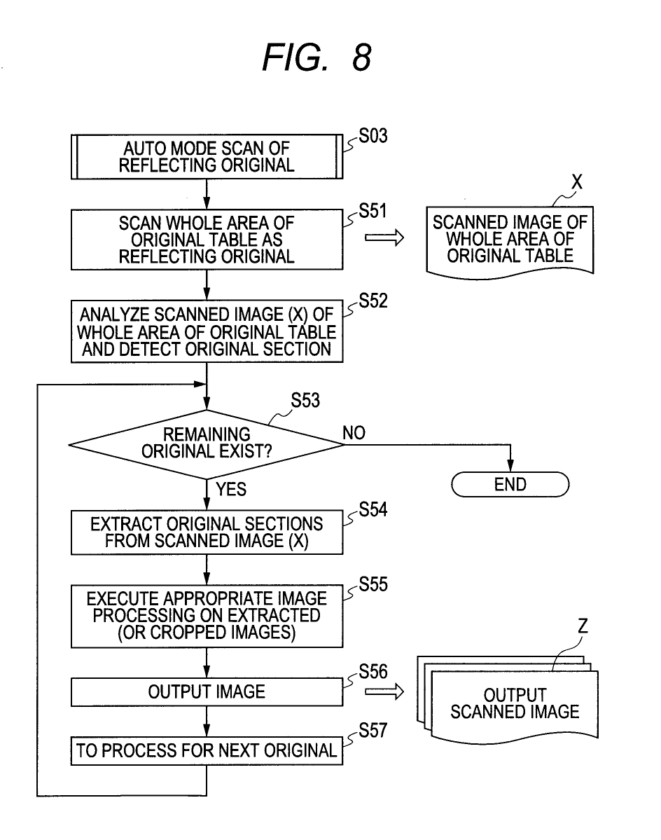

FIG. 8 is a flowchart specifically illustrating the auto mode scan of the reflecting original (S03) illustrated in FIG. 4.

The auto mode scan of the reflecting original (S03) is executed if the original type Y indicates the reflecting original in the condition discrimination illustrated in FIG. 4. In the auto mode scan of the reflecting original in SO2, if it is determined that the original type Y indicates the reflecting original, the whole area of the original table is scanned in S51 and a result of the scan is held in a function as an original table whole area scanned image X. In S52, the original table whole area scanned image X saved in the auto mode original type discrimination S01 is analyzed, thereby detecting the original portion. If it is determined in S53 that there are a plurality of originals, the plurality of originals are detected and a cropping process for extracting the original portion from the original table whole area scanned image X is executed in S54. Thus, even if the whole area of the original table is scanned, substantially the same result as that in the case where the user selected and scanned the necessary area can be obtained. The cropped image is subjected to the proper image process according to such an image in S55 and a function as an output scanned image Z is output in S56. When the plurality of originals are detected, subsequently, the processing routine advances to the processes of the next original in S57. When the original is the last original, the processing routine is terminated.

Generally, since a ratio at which the reflecting original is used is large, all originals are read on the assumption that the original is the reflecting original. By using such a method, as compared with a case where whether the original is the reflecting original or the transmitting original is discriminated every time the original is read and then the original is read based on a result of the discrimination, such an effect that the whole processing time is shorter is obtained.

In the case of reading the transmitting original, the original is temporarily read as a reflecting original and, thereafter, it is read as a transmitting original. Therefore, although the time necessary for reading the transmitting original as a reflecting original is wastefully consumed, since the number of transmitting originals is small and their ratio is small, the whole reading time is short.

That is, in the embodiment 1, if the reflecting original has been put on the table, the scanning operation adapted to discriminate the original type in the related art can be omitted as mentioned above, and the auto mode scan can be realized at a speed higher than the speed in the related art by the time corresponding to the scanning time. In other words, the average scanning time in the scan of a plurality of number of times can be shortened.

### Embodiment 2

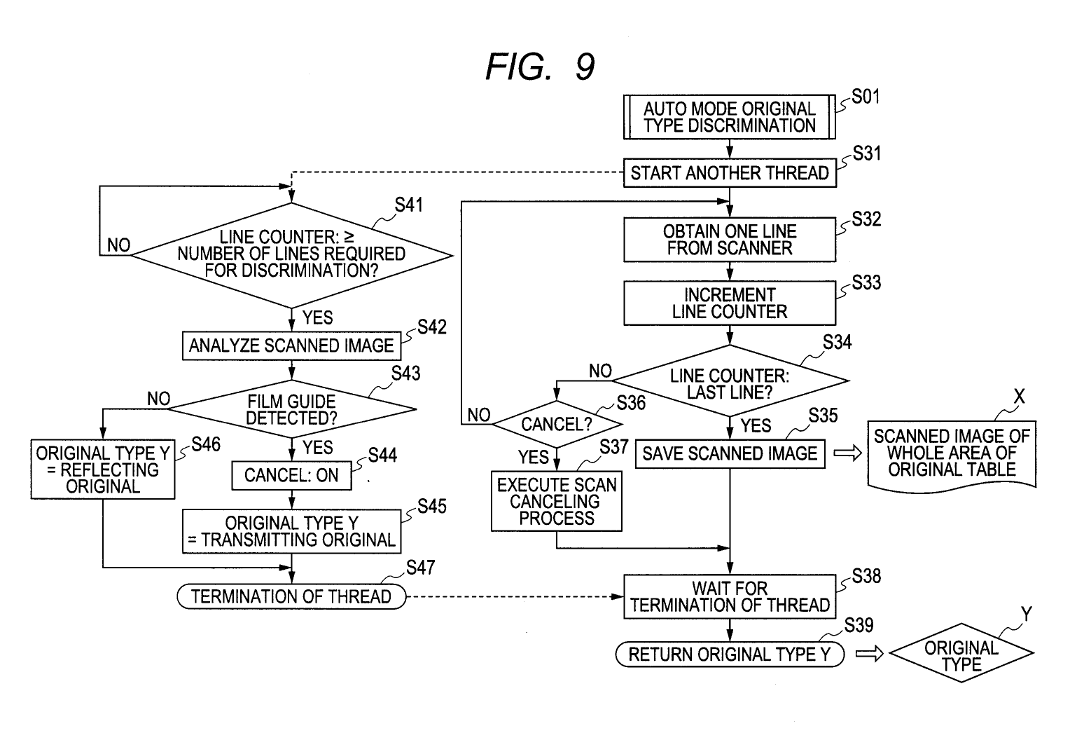

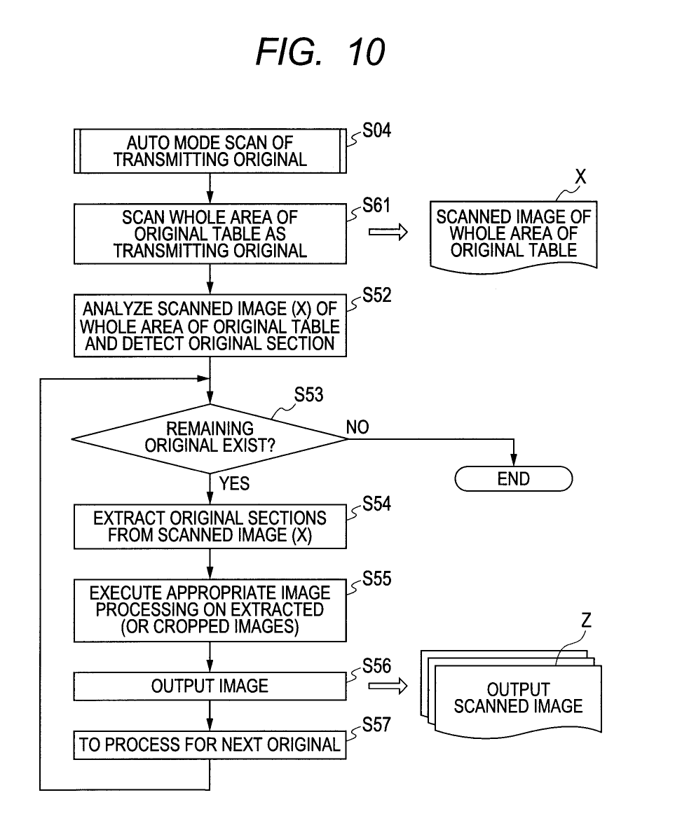

FIG. 9 is a flowchart illustrating the operation of an embodiment 2 of the invention. The embodiment 2 is illustrated in the flowchart for realizing the auto mode original type discrimination (S01) illustrated in FIG. 4 by another method.

In the embodiment 2, when the auto mode original type discrimination is started in S01, another thread is started in S31. After that, in S32, data of one line is obtained from the scanner and the obtained data is saved into a storing area in a memory, a storage, or the like. In S33, the number of lines is incremented. In S34, whether or not the number of lines counted by a line counter has reached the last line to be scanned is discriminated. If all of the lines have completely been read, in S35, the data accumulated so far is saved as an original table whole area scanned image X.

If the number of lines does not reach the last line, a cancel flag is evaluated in S36. If the cancellation is not requested, the processing routine advances to S32. If the cancellation is requested, a canceling process of the scan is executed in S37. In S38, the system waits for termination of another thread. In S39, the original type Y is returned and the processing routine is finished. If the number of lines does not reach the last line and the cancellation is not requested, the processes in S32 to S36 are repeated.

In S41, another thread formed in S31 discriminates the number of lines counted up in S33. If the number of lines does not reach the original type discriminating area 406, the discrimination in S41 is repeated. If the number of lines reaches the original type discriminating area 406, the image data is analyzed and the film guide is detected. If the film guide is not detected, in S46, the reflecting original is saved into the function as an original type Y and the thread is terminated.

If the film guide is detected, in S44, the cancel flag is set (effective), the transmitting original is saved into the function as an original type Y and the thread is terminated. The cancel flag which was set in S44 is evaluated in S36 of a main thread and the scanning operation is stopped on the halfway.

The operation in S31 to S39 and the operation in S41 to S47 are the operations in the different threads and are simultaneously processed.

That is, simultaneously with that the reading operation of the reflecting original is executed by the reflecting original reading unit, the reflecting original reading unit extracts a part of the data read as a reflecting original and, when a part of the data is obtained, the original discriminating unit discriminates the original type. If it is determined that the original is the transmitting original, the reading operation is stopped and the transmitting original reading unit reads the original as a transmitting original. If it is determined that the original is the reflecting original, the reading operation of the reflecting original by the reflecting original reading unit is continued and the data is used.

According to the embodiment 2, even if the transmitting original has been put onto the original table, the reading operation of the reflecting original on the whole area of the original table can be interrupted and the auto mode scan can be executed for the time obtained by adding a time required for the added cancelling process to the required time in the related art. Thus, a decrease in processing speed in the case of the transmitting original can be reduced. In other words, the average scanning time in the scan of a plurality of number of times can be shortened.

### Embodiment 3

An embodiment 3 of the invention is an embodiment in which the reflecting original is replaced with the transmitting original in the embodiment 1. In the embodiment 3, if the transmitting original has been put on the original table, the scan for the original type discrimination which has been executed in the related art can be omitted. The auto mode scan can be realized at a speed higher than the speed in the related art by the time corresponding to the time required for the omitted scan. In other words, the average scanning time in the scan of a plurality of number of times can be shortened.

In the embodiment 3, the electric board 106 is an example of the original discriminating unit for discriminating whether the read original is the reflecting original or the transmitting original based on a part of the data read out as a transmitting original by the transmitting original reading unit. The electric board 106 is also an example of the control unit for controlling in such a manner that if it is determined by the original discriminating unit that the original is the reflecting original, the original is read as a reflecting original by the reflecting original reading unit, and if it is determined by the original discriminating unit that the original is the transmitting original, the data which has been read before is used.

FIG. 10 is a flowchart illustrating details of the auto mode scan of the transmitting original (S04).

The auto mode scan of the transmitting original (S04) is executed when the original type Y indicates the transmitting original in the condition discrimination illustrated in FIG. 4. In the auto mode scan of the transmitting original, the original is scanned as a transmitting original. By analyzing the image data of the film preview area, the type (positive film, negative film, or the like), a shape (sleeve, mount, or the like), and a frame of the film are detected. In the auto mode scan of the transmitting original of S02, if it is determined that the original is the transmitting original, the whole area of the original table is scanned in S61 and a result of the scan is held in the function as an original table whole area scanned image X. In S52, the original table whole area scanned image X saved in the auto mode original type discrimination (S01) is analyzed and the original portion is detected. If it is decided in S53 that there are a plurality of originals, the plurality of originals are detected. In S54, a cropping process for extracting the original portion from the original table whole area scanned image X is executed. Thus, even if the whole area of the original table is scanned, substantially the same result as that in the case where the user selected and scanned the necessary area can be obtained. The cropped image is subjected to the proper image process according to such an image in S55 and a function as an output scanned image Z is output in S56. When a plurality of originals are detected, subsequently, the processing routine advances to the processes of the next original in S57. When the original is the last original, the processing routine is terminated.

If a ratio at which the transmitting original is used is large, all originals are read on the assumption that the original is the transmitting original. By using such a method, as compared with a case where whether the original is the reflecting original or the transmitting original is discriminated every time the original is read and then the original is read based on a result of the discrimination, such an effect that the whole processing time is shorter is obtained.

In the case of reading the reflecting original, the original is temporarily read as a transmitting original and, thereafter, it is read as a reflecting original. Therefore, although the time necessary for reading the reflecting original as a transmitting original is wastefully consumed, if the number of reflecting originals is small and their ratio is small, the whole reading time is short.

That is, in the embodiment 3, if the transmitting original has been put on the table, the scanning operation adapted to discriminate the original type in the related art can be omitted as mentioned above, and the auto mode scan can be realized at a speed higher than the speed in the related art by the time corresponding to the scanning time. In other words, the average scanning time in the scan of a plurality of number of times can be shortened.

### Embodiment 4

An embodiment 4 of the invention is an embodiment which is carried out by replacing the reflecting original with the transmitting original in the embodiment 2. If the reflecting original has been put on the original table, the operation to read the transmitting original can be interrupted. By the interruption of the reading operation, the auto mode scan can be executed for a period of time obtained by adding the time required for the canceling process to the required time in the related art. Therefore, a decrease in processing speed in the case of the reflecting original can be reduced. In other words, the average scanning time in the scan of a plurality of number of times can be shortened.

### Embodiment 5

An embodiment 5 of the invention is an example in which execution of the reading operation can be instructed by preliminarily registering in a registering unit the reading unit which is often used on a daily basis by the user. The embodiment 5 is an embodiment in which the whole area is read by the preregistered reading unit and, thereafter, the original type is discriminated. That is, the above registering unit is an example of a registering unit in which as a reading unit which is often used on a daily basis by the user, the reflecting original reading unit or the transmitting original reading unit is preliminarily registered into the registering unit.

Further, it is also possible to construct in such a manner that a frequency of the reading unit used by the user is previously registered into the registering unit and the reading operation is executed by using the reading unit whose use frequency is large.

Further, the reading unit which was used previously is registered into the registering unit and the reading operation may be executed by using the reading unit which was used previously.

In the embodiment 5, whether the whole area is read by the reflecting original or the whole area is read by the transmitting original can be predetermined on the side of the image reading apparatus or on the driver.

If the user who often reads the transmitting original more than the reflecting original reads the whole area by the reflecting original, thereafter, discriminates the original, and executes the auto mode scan, the time required to read the whole area by the reflecting original is wastefully consumed. To eliminate such a wasteful time, in the embodiment 5, a registering unit for enabling the user to previously register such a mode as to preferentially execute the reading operation of which one of the reflecting original and the transmitting original from the host PC 221 is provided. Thus, the fastest original type discrimination and reading process can be executed with respect to the type of original which is often used by the user on a daily basis.

### Embodiment 6

A recording medium in which program codes of software for realizing the functions of the embodiments mentioned above have been recorded can be contemplated. The object of the invention is accomplished by such a method that the recording medium is supplied to a system or an apparatus and a computer (or a CPU or MPU) of the system or apparatus reads out and executes the program codes stored in the recording medium. In this case, the program codes themselves read out of the recording medium realize the functions of the embodiments mentioned above. A storage medium in which the program codes have been recorded constructs the invention.

As a storage medium for supplying the program codes, for example, a flexible disk, a hard disk, an optical disk, a magnetooptic disk, a CD-ROM, a CD-R, a magnetic tape, a non-volatile memory card, a ROM, a DVD, or the like can be used.

An operating system (OS) or the like which is operating in a computer executes a part or all of actual processes based on instructions of the program codes read out by the computer and the functions of the embodiments mentioned above are realized by those processes.

Further, the program codes read out of the storage medium are written into a memory provided for a function expanding board inserted in the computer or a function expanding unit connected to the computer. After that, a CPU or the like provided for the function expanding board or the function expanding unit executes a part or all of the actual processes based on the instructions of the program codes and the functions of the embodiments mentioned above are realized by those processes.

According to the embodiments, a high speed of the auto mode scan in the case where the reflecting original has been put on the original table can be realized without increasing the costs of the hardware. Moreover, according to the embodiments, even if the transmitting original has been put on the original table, the reduction in speed of the auto mode scan can be suppressed.

Further, according to the embodiments, a high speed of the auto mode scan in the case where the transmitting original has been put on the original table can be realized without increasing the costs of the hardware. Moreover, according to the embodiments, even if the reflecting original has been put on the original table, the reduction in speed of the auto mode scan can be suppressed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-159258, filed Jul. 3, 2009, which is hereby incorporated by reference herein in its entirety.

What is claimed is:

1. An image reading apparatus for forming an original image by reading an original, comprising:
a reflecting original reading unit configured to read a reflecting original by reflecting light;
a transmitting original reading unit configured to read a transmitting original by transmitting the light;
an instructing unit configured to instruct an execution of either the reflecting original reading unit or the transmitting original reading unit;
an original discriminating unit configured to discriminate whether the read original is the reflecting original or the transmitting original by using a feature of image data read by the reading unit instructed by the instructing unit; and
a reading control unit configured to control in such a manner that if a discrimination result of the original discriminating unit indicates that the original is the original which can be read by the reading unit instructed by the instructing unit, an original image is formed by using the image data read by the reading unit, and if the discrimination result of the original discriminating unit indicates that the original is not the original which can be read by the reading unit instructed by the instructing unit, an original image is formed by reading the original by using the other reading unit.

2. An apparatus according to claim 1, wherein the discriminating unit discriminates whether the read original is the reflecting original or the transmitting original by using the feature which a part of the read image data has during the reading operation of the reading unit.

3. An apparatus according to claim 1, wherein the instructing unit instructs the execution of the reading unit which has previously been registered by a user.

4. An apparatus according to claim 1, wherein the instructing unit instructs the execution of the reading unit in priority order which has been predetermined by a user.

5. An apparatus according to claim 1, wherein the instructing unit instructs the execution of the reading unit whose use frequency by the user is large.

6. A control method of an image reading apparatus which has a reflecting original reading unit configured to read a reflecting original by reflecting light and a transmitting original reading unit configured to read a transmitting original by transmitting the light and forms an original image by reading the original by using one of the reading units, comprising:
an instructing step of instructing an execution of either the reflecting original reading unit or the transmitting original reading unit;
an original discriminating step of discriminating whether the read original is the reflecting original or the transmitting original by using a feature of image data read by the reading unit instructed in the instructing step; and
a reading control step of controlling in such a manner that if a discrimination result of the original discriminating step indicates that the original is the original which can be read by the reading unit instructed in the instructing step, an original image is formed by using the image data read by the reading unit, and if the discrimination result of the original discriminating step indicates that the original is not the original which can be read by the reading unit instructed in the instructing step, an original image is formed by reading the original by using the other reading unit.

7. A recording medium in which a program for controlling an image reading apparatus which has a reflecting original reading unit configured to read a reflecting original by reflecting light and a transmitting original reading unit configured to read a transmitting original by transmitting the light and forms an original image by reading the original by using one of the reading units has been recorded, wherein the program comprises:
an instructing step of instructing an execution of either the reflecting original reading unit or the transmitting original reading unit;
an original discriminating step of discriminating whether the read original is the reflecting original or the transmitting original by using a feature of image data read by the reading unit instructed in the instructing step; and
a reading control step of controlling in such a manner that if a discrimination result of the original discriminating step indicates that the original is the original which can be read by the reading unit instructed in the instructing step, an original image is formed by using the image data read by the reading unit, and if the discrimination result of the original discriminating step indicates that the original is not the original which can be read by the reading unit instructed in the instructing step, an original image is formed by reading the original by using the other reading unit.
